(19) United States
(12) Patent Application Publication
(10) Pub. No.: US 2012/0067500 A1
(43) Pub. Date: Mar. 22, 2012

(54) DEVICE FOR FABRICATING LIQUID CRYSTAL DISPLAY AND METHOD FOR FABRICATING LIQUID CRYSTAL DISPLAY

(76) Inventor: Tadashi Nishioka, Osaka (JP)

(21) Appl. No.: 13/375,339

(22) PCT Filed: Feb. 24, 2010
(86) PCT No.: PCT/JP2010/001245

§ 371 Date: Nov. 30, 2011

(30) Foreign Application Priority Data
Jul. 22, 2009 (JP) 2009-171170

(51) Int. Cl. B32B 37/00

(52) U.S. Cl. 156/60; 156/538; 156/366

(57) ABSTRACT

A liquid crystal panel P is positioned and held by a plurality of first locating pins 5 of a first holder 3 with a diagonal line of the liquid crystal panel P oriented in a vertical direction by making use of a weight of the liquid crystal panel P. A backlight B is positioned and held by a plurality of second locating pins 6 of a second holder 4 with a diagonal line of the backlight B corresponding to the diagonal line of the liquid crystal panel P extending in the vertical direction by making use of a weight of the backlight B. A bonding mechanism 13 horizontally moves the second holder 4 to bring the first and second holders 3 and 4 relatively close to each other to bond the liquid crystal panel P and the backlight B. This allows easy and precise positioning and bonding of the objects.

### TECHNICAL FIELD

The present invention relates to a device and a method for fabricating a liquid crystal display by bonding a pair of plates constituting the liquid crystal display.

### BACKGROUND ART

For example, Patent Document 1 discloses a method for fabricating a liquid crystal display. According to this method, pre-alignment is performed in the following manner. A liquid crystal substrate in a cassette is placed on a robot arm to transfer the substrate to a pre-alignment region. The robot arm is moved in a Y-axis direction, and an angle of inclination of a side X of the liquid crystal substrate relative to an X-axis is obtained using two Y-axis position sensors. The liquid crystal substrate is then placed on four chuck pins, a rotating table is rotated in a clockwise direction by a predetermined angle, and the liquid crystal substrate is held by the robot arm by means of suction. Then, the rotating table is rotated in a counterclockwise direction by a predetermined angle, and the position of the liquid crystal substrate in the Y-axis direction is determined. Then, a robot body is moved along a rail in the X-axis direction, and a side Y of the liquid crystal substrate is detected by an X-axis position sensor.

According to Patent Document 2, a master plate and a hologram sensitive glass substrate having the same dimension are positioned by bringing them into contact with locating pins, or fitting them in a frame. Alternatively, the positioning is performed by providing locating markers in the master plate and the hologram sensitive glass substrate, respectively, and making the markers coincide with each other to perform hologram reproduction.

### CITATION LIST

### Patent Documents

[Patent Document 1] Japanese Patent Publication No. H09-138256
[Patent Document 2] Japanese Patent Publication No. H09-96723

### SUMMARY OF THE INVENTION

### Technical Problem

In a conventional step of bonding a liquid crystal panel placed on a horizontal plane and a backlight placed on a horizontal plane, the liquid crystal panel and the backlight need to be bonded with high precision. The precision in bonding the liquid crystal panel and the backlight is based on sides of the liquid crystal panel and the backlight in X and Y directions. For example, as shown in FIG. 10, the liquid crystal panel P is manually slid in a horizontal direction to visually position a side x extending in the X direction, and a side y extending in the Y direction perpendicular to the X direction of the liquid crystal panel P relative to locating pins 105. This operation relies on a sense of an operator, and the positioning tends to be imprecise. Thus, the liquid crystal panel and the backlight may be misaligned with or inclined from each other.

As shown in FIGS. 11 and 12, when cylinders 106 etc. are used to press the liquid crystal panel P or the backlight B from a direction opposite the locating pins toward the locating pins, a housing of the liquid crystal panel P or the backlight B may be chipped or cracked if a force for pressing the liquid crystal panel P or the backlight B is too large, a speed of the liquid crystal panel P or the backlight B is too high, or the locating pins 105 are too hard. As a result, defective products may be fabricated.

If the housing of the backlight B is not stiff, the backlight experiences distortion d as shown in FIG. 12, and cannot precisely be bonded to the liquid crystal panel.

In view of the foregoing, the present invention has been achieved. The present invention is concerned with easy and precise positioning and bonding of objects.

### Solution to the Problem

In view of the above concern, according to the present invention, the objects are held in such a manner that diagonal lines of the objects corresponding to each other are oriented in a vertical direction perpendicular to a horizontal line.

Specifically, a first aspect of the invention is directed to a device for fabricating a liquid crystal display by bonding a first plate and a second plate constituting the liquid crystal display.

The device includes: a first holder including a plurality of first locating pins for positioning and holding the first plate in such a manner that one of diagonal lines of the first plate is oriented in a vertical direction by making use of a weight of the first plate; a second holder including a plurality of second locating pins for positioning and holding the second plate in such a manner that a diagonal line of the second plate corresponding to the diagonal line of the first plate is oriented in the vertical direction by making use of a weight of the second plate; and a bonding mechanism for moving at least one of the first holder or the second holder in a horizontal direction to bring the first holder and the second holder relatively close to each other.

According to the above configuration, each of the plates is positioned by sliding the plate by making use of its own weight with an outer peripheral surface of the plate in contact with the locating pins. Thus, the locating pins do not excessively press the plate, and the plate is not chipped or cracked. The correctly positioned plates are bonded with high precision by bringing the plates close to each other. The vertical direction indicates a direction in which gravity perpendicular to the horizontal line is exerted.

In a second aspect of the invention related to the first aspect of the invention, some of the plurality of first locating pins are aligned in an X direction to abut a first side of the first plate extending in the X direction, and the other first locating pins are aligned in a Y direction to abut a second side of the first plate extending in the Y direction, and some of the plurality of second locating pins are aligned in the X direction to abut a first side of the second plate extending in the X direction, and the other second locating pins are aligned in the Y direction to abut a second side of the second plate extending in the Y direction.

According to the above configuration, one of the first side or the second side of the first plate is brought into contact with the corresponding first locating pins aligned in the X or Y direction, and the first plate is slid along the first locating pins until it abuts the other first locating pins. Thus, the first plate is positioned. Likewise, one of the first side or the second side of the second plate is brought into contact with the corresponding second locating pins aligned in the X or Y direction, and the second plate is slid along the second locating pins until it abuts the other second locating pins. Thus, the second plate is positioned.

In a third aspect of the invention related to the first or second aspect of the invention, at least one of the first holder or the second holder is configured to be movable in a horizontal direction, a vertical direction, and an angular direction.

According to the above configuration, minor misalignment between the first and second plates in the X and Y directions can be corrected, and the first and second plates can precisely be bonded.

In a fourth aspect of the invention related to any one of the first to third aspects of the invention, the first holder includes a first suction mechanism which holds and releases the first plate by means of suction, and the second holder includes a second suction mechanism which holds and releases the second plate by means of suction.

According to the above configuration, even when the first or second locating pins are moved to avoid possible interference between the first locating pins and the second locating pins, the plates can be kept at the correct position, and the bonded plates can be released.

In a fifth aspect of the invention related to the fourth aspect of the invention, at least one of the first locating pins or the second locating pins is provided on an avoidance mechanism for avoiding contact with the other of the first locating pins or the second locating pins, the avoidance mechanism includes a cylinder for avoiding the contact with the locating pins, and a slide member which is slid by the cylinder for avoiding the contact with the locating pins, and the first locating pins or the second locating pins are provided on the slide member.

According to the above configuration, even when at least one of the first locating pins or the second locating pins is moved by sliding the slide member by extending or contracting the cylinder for avoiding the contact with the locating pins while at least one of the first suction mechanism or the second suction mechanism being operated, the first suction mechanism holds the first plate by means of suction, and the second suction mechanism holds the second plate by means of suction. Thus, the first and second plates are not misaligned, and the contact between the first locating pins and the second locating pins can be prevented without misalignment between the first and second plates.

In a sixth aspect of the invention related to any one of the first to fifth aspects of the invention, the bonding mechanism includes an air cylinder, a regulator, and a timer.

According to the above configuration, the air cylinder is controlled by the regulator and the timer to suitably bond the first plate and the second plate by an appropriate force in an appropriate period of time.

In a seventh aspect of the invention related to any one of the first to sixth aspect of the invention, each of the first locating pins and the second locating pins includes a metal pin body, and a resin collar covering the pin body.

According to the above configuration, the resin collars of the locating pins abut the first plate and the second plate. Thus, the first plate and the second plate are hardly chipped or cracked.

In an eighth aspect of the invention related to any one of the first to seventh aspects of the invention, the first plate is a liquid crystal panel, and the second plate is a backlight.

According to the above configuration, the backlight can be bonded to the liquid crystal panel with high precision without chipping or cracking.

In a ninth aspect of the invention related to any one of the first to seventh aspects of the invention, the first plate is a touch panel, and the second plate is a liquid crystal module including a liquid crystal panel and a backlight.

According to the above configuration, the touch panel can be bonded to the liquid crystal module obtained by bonding the liquid crystal panel and the backlight with high precision without chipping or cracking.

A tenth aspect of the invention is directed to a method for fabricating a liquid crystal display by bonding a first plate and a second plate constituting the liquid crystal display. The method includes: preparing a fabrication device including a first holder having a plurality of first locating pins, and a second holder having a plurality of second locating pins; positioning and holding the first plate in such a manner that one of diagonal lines of the first plate is oriented in a vertical direction by bringing an outer peripheral surface of the first plate into contact with the first locating pins; positioning and holding the second plate in such a manner that a diagonal line of the second plate corresponding to the diagonal line of the first plate is oriented in the vertical direction by bringing an outer peripheral surface of the second plate into contact with the second locating pins; and bonding the first plate and the second plate by bringing the first holder and the second holder relatively close to each other.

According to the above configuration, each of the plates is positioned by making use of its own weight in such a manner that one of the diagonal lines is oriented in the vertical direction by bringing the outer peripheral surface of the plate into contact with the corresponding locating pins. Thus, the locating pins do not excessively press the plate, and the plate is not chipped or cracked. The plates can be bonded with high precision by bringing the correctly positioned plates relatively close to each other.

In an eleventh aspect of the invention related to the tenth aspect of the invention, the first plate is positioned by bringing one of a first side or a second side of the first plate into contact with the first locating pins aligned in one of an X direction or a Y direction to slide the first plate along the first locating pins until it abuts the first locating pins aligned in the other of the X direction or the Y direction, and the second plate is positioned by bringing one of a first side or a second side of the second plate into contact with the second locating pins aligned in one of the X direction or the Y direction to slide the second plate along the second locating pins until it abuts the second locating pins aligned in the other of the X direction or the Y direction.

According to the above configuration, the first and second plates can be positioned smoothly and precisely by making their own weight. Thus, an excessive force is no longer applied to the plates, and the first and second plates are not chipped or cracked.

### Advantages of the Invention

According to the present invention described above, the first plate and the second plate are positioned by making use of their own weight, and are bonded. This allows easy and precise positioning and bonding of targets.

### BRIEF DESCRIPTION OF THE DRAWINGS

FIG. 1 is a side view illustrating a device for fabricating a liquid crystal display according to an embodiment of the present invention.

FIG. 2 is a view illustrating the device for fabricating the liquid crystal display as viewed in a direction of an arrow II in FIG. 3.

FIG. 3 is a cross-sectional view taken along the line III-III in FIG. 1.

FIG. 4 is a view corresponding to FIG. 3 in which the liquid crystal panel is not placed yet.

FIG. 5 is a front view of a backlight.

FIGS. 6(a) and 6(b) are a side view and a front view illustrating how the liquid crystal panel is positioned on a first holder.

FIGS. 7(a) and 7(b) are front views illustrating how the liquid crystal panel is positioned along first locating pins, FIG. 7(a) shows that the liquid crystal panel is positioned by a second side thereof, FIG. 7(b) shows that the liquid crystal panel is positioned by a second side thereof.

FIGS. 8(a) and 8(b) are a side view and a front view illustrating the liquid crystal panel positioned on the first holder.

FIG. 9 is a front view illustrating the first locating pins moved downward.

FIG. 10 is a plan view illustrating a conventional liquid crystal panel which is positioned by horizontally sliding the liquid crystal panel.

FIG. 11 is a plan view illustrating a conventional liquid crystal panel which is positioned by pressing sides of the liquid crystal panel with cylinders.

FIG. 12 is a plan view illustrating how a conventional backlight is damaged.

### DESCRIPTION OF EMBODIMENTS

An embodiment of the present invention will be described below with reference to the drawings.

### —Structure of Device for Fabricating Liquid Crystal Display—

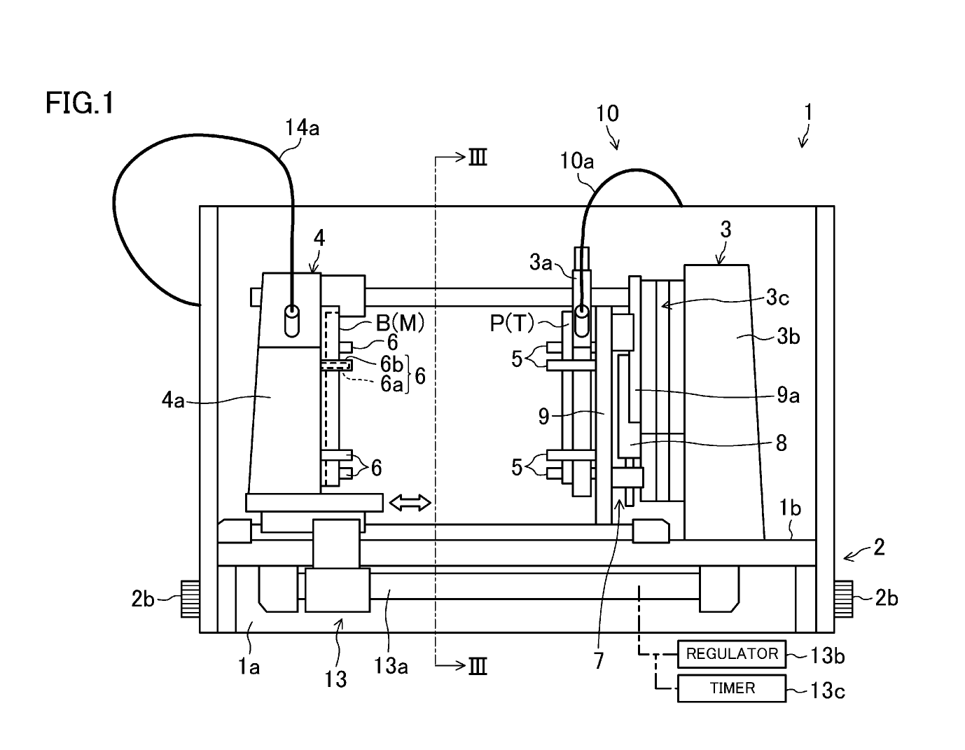

FIGS. 1-3 show a device 1 for fabricating a liquid crystal display according to an embodiment of the present invention. For example, the device 1 is used to bond a liquid crystal panel P and a backlight B as a first plate and a second plate constituting the liquid crystal display (not shown).

The fabrication device 1 includes a stationary table 1a fixed to a floor etc. A support table 1b is rotatably supported on the stationary table 1a. Specifically, the fabrication device 1 includes a diagonal line adjustment mechanism 2 for orienting a diagonal line in a vertical direction. A rotating lever 2b of the support table 1b is arranged in an arc-shaped guide groove 2a formed in a lower portion of each side surface of the stationary table 1a. When the rotating lever 2b is operated, the rotating lever 2b moves in the guide groove 2a, and the support table 1b is rotated relative to the stationary table 1a.

A first holder 3 and a second holder 4 which are relatively movable in a horizontal direction are provided on the support table 1b.

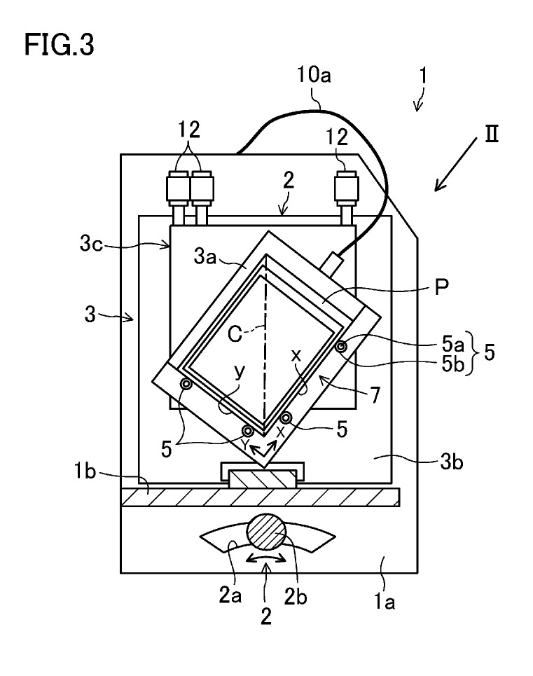

Specifically, the first holder 3 includes a first holder plate 3a for holding the liquid crystal panel P by means of suction. The first holder plate 3a is inclined in advance as shown in FIG. 3 in such a manner that longer one of two diagonal lines of the liquid crystal panel P, i.e., a diagonal line C, is oriented in a vertical direction perpendicular to a horizontal line. A plurality of first locating pins 5 (four pins in this embodiment) protrude from the first holder plate 3a (from an avoidance mechanism 7 described later in a strict sense). As shown in FIG. 3, each of the first locating pins 5 includes a solid or hollow metal pin body 5a, and a resin collar 5b covering the pin body 5a. The resin collar 5b is made of a material which is as soft as possible not to chip or crack the liquid crystal panel P. The first locating pins 5 are provided on an avoidance mechanism 7 for avoiding contact with second locating pins 6. Specifically, the avoidance mechanism 7 includes a cylinder 8 for moving the locating pins, and a slide member 9 which is slid by the cylinder 8. As shown in FIG. 9, the slide member 9 is in the shape of L when viewed in plan, and is fitted on vertically extending rails 9a to be slidable in the vertical direction. The four first locating pins 5 are arranged on the slide member 9 to support a first side x of the liquid crystal panel P extending in the X direction, and to support a second side y of the liquid crystal panel P extending in the Y direction perpendicular to the X direction. For example, as shown in FIG. 3, two of the first locating pins 5 are aligned in the X direction of the first holder plate 3a, and the other two first locating pins 5 are aligned in the Y direction. Thus, the liquid crystal panel P is positioned and held by the first locating pins 5 in such a manner that the diagonal line C is oriented in the vertical direction by making use of a weight of the liquid crystal panel P.

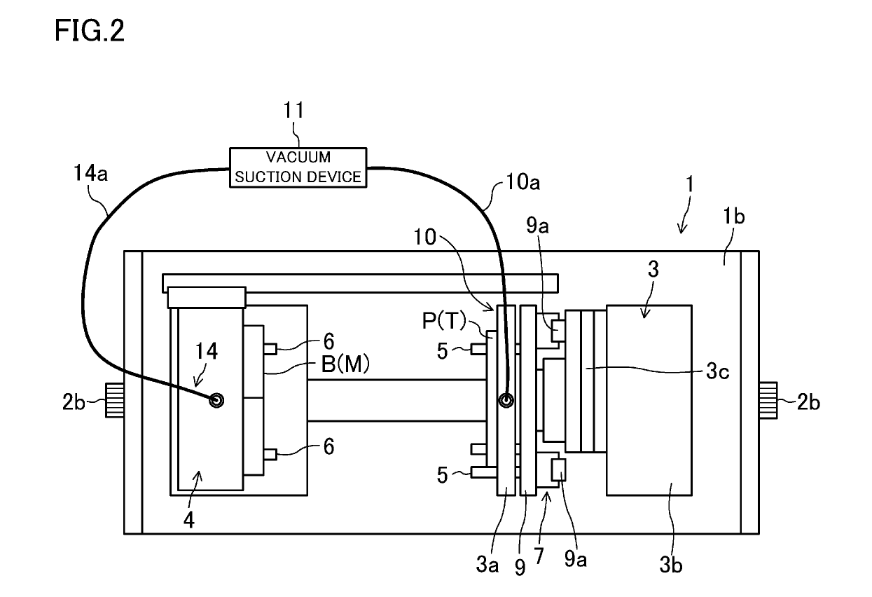

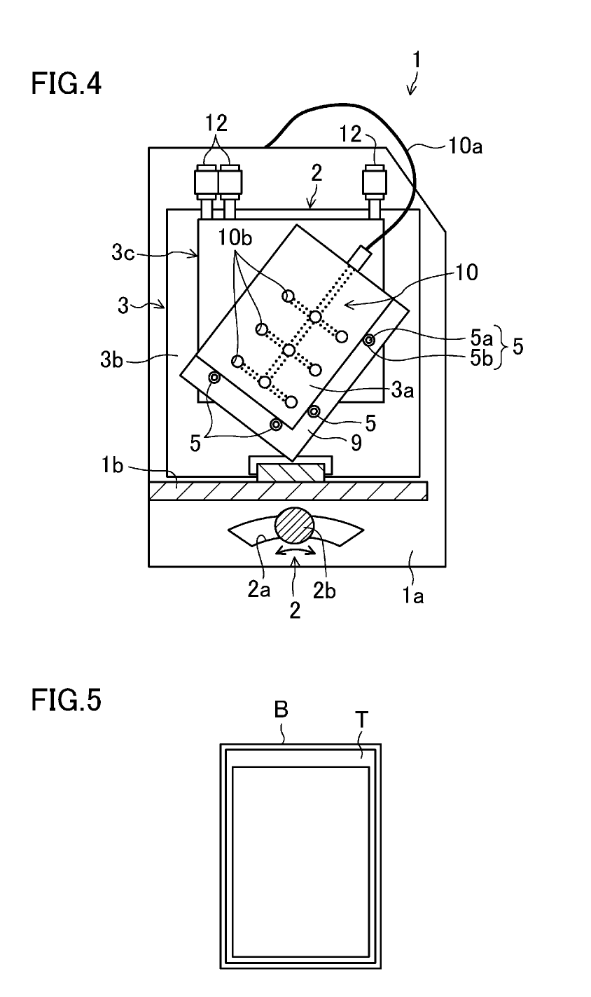

The first holder 3 includes a first suction mechanism 10 which holds and releases the liquid crystal panel P by means of suction. As shown in FIGS. 2 and 4, the first suction mechanism 10 includes an air suction tube 10a connected to a vacuum suction device 11 such as a vacuum pump, and a plurality of (9 in this embodiment) vacuum suction holes 10b formed in the first holder plate 3a. The vacuum suction holes 10b and the air suction tube 10a communicate with each other in the first holder plate 3a. When the vacuum suction device 11 is operated to suck air through the air suction tube 10a, the liquid crystal panel P sticks to the first holder plate 3a by means of suction. The liquid crystal panel P is released from the first holder plate 3a when the vacuum suction device 11 is stopped.

The first holder 3 further includes a fine adjustment mechanism 3c which can move the liquid crystal panel P in a horizontal direction, a vertical direction, and an angular direction. The fine adjustment mechanism 3c can make a fine adjustment of the position of the liquid crystal panel P. Although details are not shown, the first holder plate 3a and the slide member 9 are supported to be movable in the horizontal direction, the vertical direction, and the angular direction relative to a first support portion 3b of the first holder 3 fixed to the support table 1b. When three knobs 12 provided on the first support portion 3b (shown in FIGS. 3 and 4 only) are operated, the slide member 9 is moved horizontally or vertically, or rotated, thereby making a fine adjustment of the position of the liquid crystal panel P relative to the backlight B supported on the second holder 4. The second holder 4 may be configured to be movable in the horizontal direction, the vertical direction, and the angular direction, or alternatively, both of the first holder 3 and the second holder 4 may be configured to be movable in the horizontal direction, the vertical direction, and the angular direction.

The second holder 4 includes a plurality of second locating pins 6 on a second holder plate 4a for holding the backlight B. The second locating pins 6 are arranged to position and hold the backlight B in such a manner that longer one of two diagonal lines of the backlight B corresponding to the diagonal line C of the liquid crystal panel P is oriented in the vertical direction by making use of a weight of the backlight B. For example, among four second locating pins 6, two second locating pins 6 are aligned in the X direction to support a first side of the backlight B extending in the X direction, and the other two second locating pins 6 are aligned in the Y direction to support a second side of the backlight B extending in the Y direction perpendicular to the X direction. Each of the second locating pins 6 includes a solid or hollow metal pin body 6a, and a resin collar 6b covering the pin body 6a. Like the first locating pins 5, the second locating pins 6 may be provided on the avoidance mechanism 7. The avoidance mechanism 7 may be provided only in the second holder 4.

As shown in FIG. 1, the second holder 4 is configured to be slid by a bonding mechanism 13 in the horizontal direction to adjust a horizontal position of the second holder 4 relative to the first holder 3. The bonding mechanism 13 includes an air cylinder 13a, a regulator 13b, and a timer 13c. For example, the regulator 13b can adjust a bonding pressure in a range of 0 to about 120 N. The bonding pressure is generally set to 30±5 N. Time for the bonding can be set to, e.g., up to 10 seconds, by using the timer 13c, and is generally set to 2±0.5 seconds. Only the first holder 3 may be configured to be movable in the horizontal direction, or both of the first holder 3 and the second holder 4 may be configured to be movable in the horizontal direction.

As shown in FIG. 5, a double-sided tape T which is in the shape of a rectangular frame is adhered to a periphery of the backlight B. When the liquid crystal panel P is pressed with an appropriate pressure, the backlight B is bonded to the liquid crystal panel P with the double-sided tape T. The double-sided tape T is shaped not to cover a display region of the liquid crystal panel P.

The second holder 4 includes a second suction mechanism 14 which holds and releases the backlight B by means of suction. Although details are not shown, the second suction mechanism 14 includes an air suction tube 14a connected to the vacuum suction device 11, and a plurality of vacuum suction holes formed in a second holder plate 4a. The vacuum suction holes and the air suction tube 14a communicate with each other in the second holder plate 4a.

### —Method for Fabricating Liquid Crystal Display—

A method for fabricating the liquid crystal display according to the present embodiment will be described below. Specifically, a method for fabricating the liquid crystal display by bonding the liquid crystal panel P constituting the liquid crystal display and the backlight B will be described.

First, the fabrication device 1 including the first holder 3 having the plurality of first locating pins 5, and the second holder 4 having the plurality of second locating pins 6 is prepared. Then, the support table 1b is rotated relative to the stationary table 1a by operating the rotating lever 2b in such a manner that the liquid crystal panel P can be positioned by the first locating pins 5 with the diagonal line C oriented in the vertical direction, and the backlight B can be positioned by the second locating pins 6 with a longer diagonal line of the backlight B oriented in the vertical direction.

Then, an outer peripheral surface of the liquid crystal panel P is brought into contact with the first locating pins 5 to position and hold the liquid crystal panel P with the diagonal line C oriented in the vertical direction.

Specifically, as shown in FIG. 6, the liquid crystal panel P is slowly moved toward the first locating pins 5 from above along the first holder plate 3a.

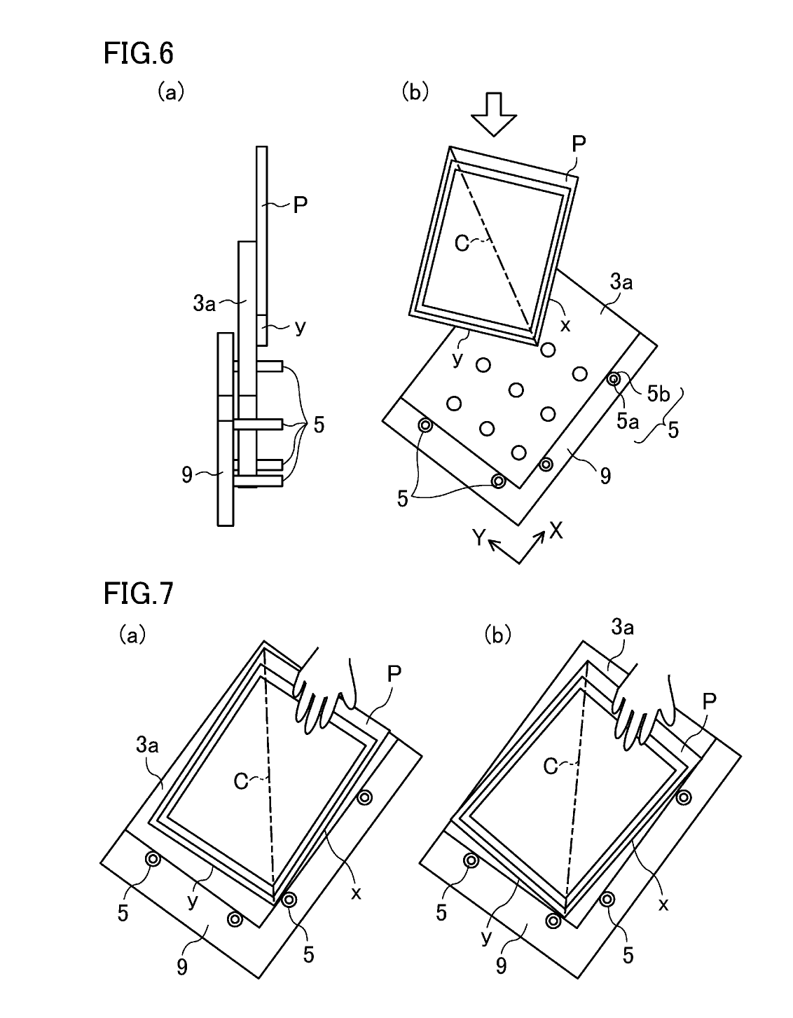

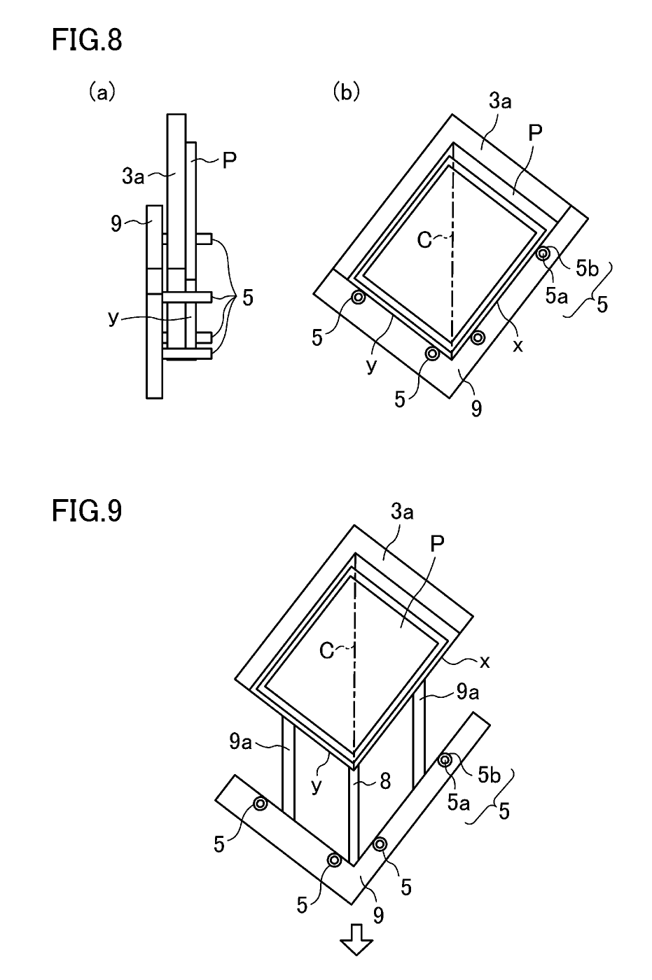

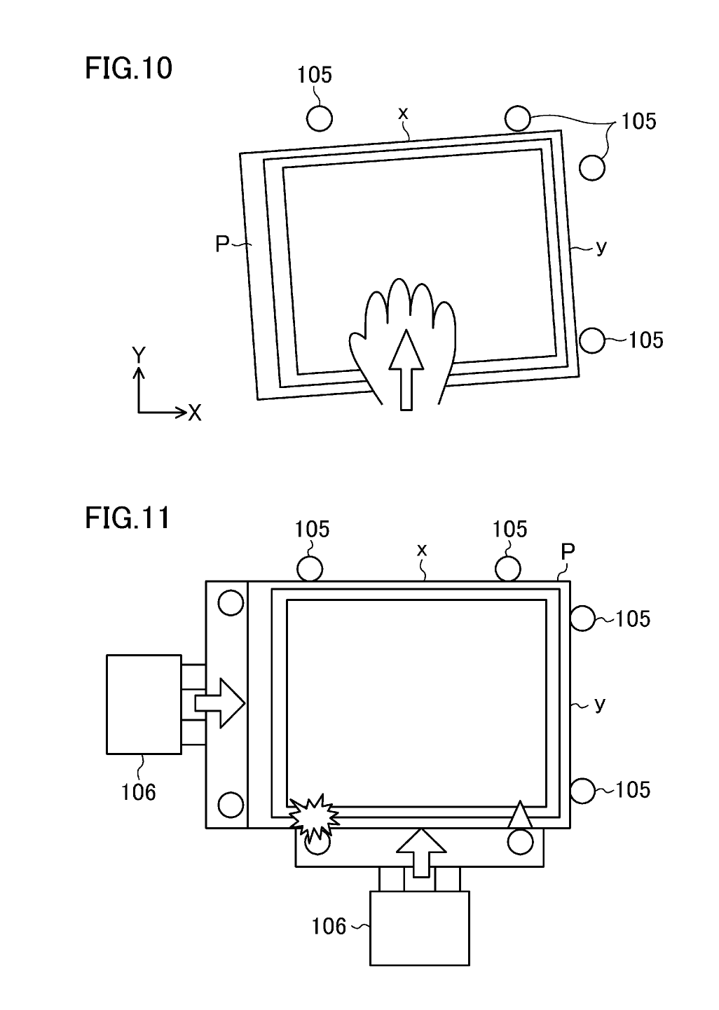

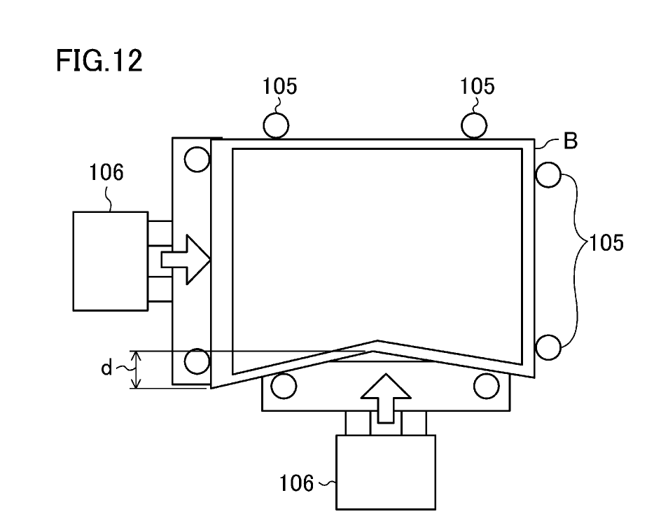

As shown in FIG. 7(a), the liquid crystal panel P is placed with the first side x of the liquid crystal panel P in contact with the first locating pins 5 aligned in the X direction, and the liquid crystal panel P is released. Then, the liquid crystal panel P slides along the first locating pins 5 aligned in the X direction by its own weight, and the second side y abuts the first locating pins 5 aligned in the Y direction. Thus, the liquid crystal panel P is positioned. Alternatively, as shown in FIG. 7(b), the liquid crystal panel P is placed with the second side y in contact with the first locating pins 5 aligned in the Y direction, and the liquid crystal display P is released. Then, the liquid crystal panel P slides along the first locating pins 5 aligned in the Y direction by its own weight, and the first side x abuts the first locating pins 5 aligned in the X direction. Thus, the liquid crystal display P is positioned. In this manner, corners of the liquid crystal panel P are correctly positioned by the four first locating pins 5 as shown in FIG. 8. At this time, the liquid crystal panel P is hardly chipped or cracked because the resin collars 5b of the first locating pins 5 abut the liquid crystal panel P.

In the same manner, first and second sides of the backlight B are brought into contact with the second locating pins 6 in turn to hold the backlight B by the second locating pins 6 with the longer diagonal line of the backlight B oriented in the vertical direction. Like the liquid crystal panel P, the backlight B is positioned by the second locating pins 6 by making use of its own weight. The backlight B is hardly chipped or cracked because the resin collars 6b of the second locating pins 6 abut the backlight B.

Then, the vacuum suction device 11 is operated to suck the air through the air suction tube 10a to hold the liquid crystal panel P on the first holder plate 3a. The backlight B is also held on the second holder plate 4a by sucking the air through the air suction tube 14a.

If a fine adjustment of the position of the liquid crystal panel P relative to the position of the backlight B is required, the liquid crystal panel P is moved in the horizontal or vertical direction, or is rotated by operating the knobs 12. Thus, minor misalignment of the liquid crystal panel P relative to the backlight B is corrected.

The liquid crystal panel P and the backlight B are slid to bring their outer peripheral surfaces (the first side x and the second side y) into contact with the first or second locating pins 5, 6 by making use of their own weight. Thus, the first or second locating pins 5, 6 do not excessively press the liquid crystal panel P or the backlight B, and the liquid crystal panel P or the backlight B is not cracked or chipped.

Then, the first holder 3 and the second holder 4 are brought relatively close to each other to bond the liquid crystal panel P and the backlight B.

Specifically, if the second holder 4 is horizontally moved as it is, the first locating pins 5 and the second locating pins 6 may interfere with each other. Thus, as shown in FIG. 9, the cylinder 8 for moving the locating pins is driven to slide the slide member 9 downward to move the first locating pins 5. Since the liquid crystal panel P is held by the first suction mechanism 10 by means of suction, the liquid crystal panel P can be kept at the correct position, and is not misaligned even when the first locating pins 5 are moved to prevent possible interference between the first and second locating pins 5 and 6.

A pressure of the air cylinder 13a is adjusted to, e.g., 30 N, by the regulator 13b, and the air cylinder 13a is extended to bring the liquid crystal panel P and the backlight B into contact with each other. Then, the timer 13c is started, and the liquid crystal panel P and the backlight B are pressed for 2 seconds. The regulator 13b prevents excessive increase of the pressure, thereby preventing damage to the liquid crystal panel P and the backlight B. The liquid crystal panel P and the backlight B are pressed for an appropriate period of time measured by the timer 13c to tightly bond the double-sided tape T to the liquid crystal panel P.

Finally, the vacuum suction device 11 is stopped, and a liquid crystal module obtained by bonding the liquid crystal panel P and the backlight B is removed.

Thus, according to the present embodiment, the liquid crystal panel P and the backlight B are positioned by making use of their own weight, and are bonded to each other. Therefore, the liquid crystal panel P and the backlight B can easily and precisely be positioned and bonded.

### Other Embodiments

The embodiment of the present invention may be modified in the following manner.

In the above-described embodiment, the liquid crystal panel P and the backlight B are described as the first plate and the second plate. However, as indicated in brackets only in FIGS. 1 and 2, the first plate may be a touch panel T, and the second plate may be a liquid crystal module M obtained by bonding the liquid crystal panel P and the backlight B. The touch panel T and the liquid crystal module M can be bonded to each other by the same steps after the fabrication of the liquid crystal display described above. Thus, the touch panel T can be bonded to the liquid crystal module with high precision without chipping or cracking.

The above-described embodiment has been set forth merely for the purposes of preferred examples in nature, and is not intended to limit the scope, applications, and use of the invention.

### INDUSTRIAL APPLICABILITY

As described above, the present invention is useful for a device and a method for fabricating a liquid crystal display by bonding a pair of plates.

### DESCRIPTION OF REFERENCE CHARACTERS

1 Device for fabricating liquid crystal display
3 First holder
3c Fine adjustment mechanism
4 Second holder
5 First locating pin
5a Pin body
5b Resin collar
Second locating pin
6a Pin body
6b Resin collar
7 Avoidance mechanism
8 Cylinder for moving locating pins
9 Slide member
10 First suction mechanism
10a Air suction tube
10b Vacuum suction hole
11 Vacuum suction device
13 Bonding mechanism
13a Air cylinder
13b Regulator
13c Timer
14 Second suction mechanism
P Liquid crystal panel (first plate)
B Backlight (second plate)
C Diagonal line (one of diagonal lines)
T Touch panel
M Liquid crystal module
x First side
y Second side

1. A device for fabricating a liquid crystal display by bonding a first plate and a second plate constituting the liquid crystal display, the device comprising:
a first holder including a plurality of first locating pins for positioning and holding the first plate in such a manner that one of diagonal lines of the first plate is oriented in a vertical direction by making use of a weight of the first plate;
a second holder including a plurality of second locating pins for positioning and holding the second plate in such a manner that a diagonal line of the second plate corresponding to the diagonal line of the first plate is oriented in the vertical direction by making use of a weight of the second plate; and
a bonding mechanism for moving at least one of the first holder or the second holder in a horizontal direction to bring the first holder and the second holder relatively close to each other.

2. The device for fabricating the liquid crystal display of claim 1, wherein
some of the plurality of first locating pins are aligned in an X direction to abut a first side of the first plate extending in the X direction, and the other first locating pins are aligned in a Y direction to abut a second side of the first plate extending in the Y direction, and
some of the plurality of second locating pins are aligned in the X direction to abut a first side of the second plate extending in the X direction, and the other second locating pins are aligned in the Y direction to abut a second side of the second plate extending in the Y direction.

3. The device for fabricating the liquid crystal display of claim 1, wherein
at least one of the first holder or the second holder is configured to be movable in a horizontal direction, a vertical direction, and an angular direction.

4. The device for fabricating the liquid crystal display of claim 1 wherein
the first holder includes a first suction mechanism which holds and releases the first plate by means of suction, and
the second holder includes a second suction mechanism which holds and releases the second plate by means of suction.

5. The device for fabricating the liquid crystal display of claim 4, wherein
at least one of the first locating pins or the second locating pins is provided on an avoidance mechanism for avoiding contact with the other of the first locating pins or the second locating pins,
the avoidance mechanism includes
a cylinder for avoiding the contact with the locating pins, and
a slide member which is slid by the cylinder for avoiding the contact with the locating pins, and
the first locating pins or the second locating pins are provided on the slide member.

6. The device for fabricating the liquid crystal display of claim 1, wherein
the bonding mechanism includes an air cylinder, a regulator, and a timer.

7. The device for fabricating the liquid crystal display of claim 1, wherein
each of the first locating pins and the second locating pins includes a metal pin body, and a resin collar covering the pin body.

8. The device for fabricating the liquid crystal display of claim 1, wherein
the first plate is a liquid crystal panel, and
the second plate is a backlight.

9. The device for fabricating the liquid crystal display of claim 1, wherein
the first plate is a touch panel, and
the second plate is a liquid crystal module including a liquid crystal panel and a backlight.

10. A method for fabricating a liquid crystal display by bonding a first plate and a second plate constituting the liquid crystal display, the method comprising:
preparing a fabrication device including a first holder having a plurality of first locating pins, and a second holder having a plurality of second locating pins;
positioning and holding the first plate in such a manner that one of diagonal lines of the first plate is oriented in a vertical direction by bringing an outer peripheral surface of the first plate into contact with the first locating pins;
positioning and holding the second plate in such a manner that a diagonal line of the second plate corresponding to the diagonal line of the first plate is oriented in the vertical direction by bringing an outer peripheral surface of the second plate into contact with the second locating pins; and
bonding the first plate and the second plate by bringing the first holder and the second holder relatively close to each other.

11. The method for fabricating the liquid crystal display of claim 10, wherein
the first plate is positioned by bringing one of a first side or a second side of the first plate into contact with the first locating pins aligned in one of an X direction or a Y direction to slide the first plate along the first locating pins until the other of the first side or the second side abuts the first locating pins aligned in the other of the X direction or the Y direction, and
the second plate is positioned by bringing one of a first side or a second side of the second plate into contact with the second locating pins aligned in one of the X direction or the Y direction to slide the second plate along the second locating pins until the other of the first side or the second side abuts the second locating pins aligned in the other of the X direction or the Y direction.
